(19) United States
(12) Patent Application Publication
(10) Pub. No.: US 2025/0309798 A1
(43) Pub. Date: Oct. 2, 2025

(54) ELECTRIC APPARATUS AND CONTROL METHOD OF ELECTRIC APPARATUS

(71) Applicant: HONDA MOTOR CO., LTD., Tokyo (JP)

(72) Inventors: Yoshihisa Kubota, Wako-shi (JP); Kiyoshi Asami, Wako-shi (JP)

(21) Appl. No.: 19/037,317

(22) Filed: Jan. 27, 2025

(30) Foreign Application Priority Data
Mar. 27, 2024 (JP) 2024-052101

(51) Int. Cl. H02P 7/293; H02J 7/14; H02P 7/03

(52) U.S. Cl. CPC H02P 7/293; H02J 7/14; H02P 7/04; H02P 2207/055

(57) ABSTRACT

An electric apparatus includes: an electricity storage device; a rotary electric machine including an α-phase first coil and an α-phase second coil; and an electric power control unit that controls electric power transfer of each of the electricity storage device and the rotary electric machine. The electric power control unit includes: a first full-bridge circuit connected to both ends of the α-phase first coil; and a second full-bridge circuit connected to both ends of the α-phase second coil. When electric power is transmitted via the α-phase first coil and the α-phase second coil between the first full-bridge circuit and the second full-bridge circuit, the electric power control unit controls a phase difference between the first full-bridge circuit and the second full-bridge circuit in a range that includes 90° to 180°.

### CROSS-REFERENCE TO RELATED APPLICATION

Priority is claimed on Japanese Patent Application No. 2024-052101, filed on Mar. 27, 2024, the contents of which are incorporated herein by reference.

### BACKGROUND

### Field of the Invention

The present invention relates to an electric apparatus and a control method of an electric apparatus.

### Background

In recent years, in order to ensure that more people have access to affordable, reliable, sustainable, and advanced energy, research and development relating to charging and electric power supply in a mobility on which a secondary battery is mounted, which contributes to energy efficiency, has been conducted.

In the related art, for example, as an insulation-type bidirectional converter used for electric power conversion in charging and electric power supply, a DAB (Dual Active Bridge) type DC-DC converter having a bridge circuit using a switching element on each of primary and secondary sides of a transformer is known (for example, refer to Japanese Unexamined Patent Application, First Publication No. 2016-152687).

### SUMMARY

In the technique relating to charging and electric power supply in a mobility on which a secondary battery is mounted, when the DAB type of DC-DC converter is formed by the combination of a stator winding of a motor and the bridge circuit using the switching element, it is a problem to prevent reduction of the efficiency. For example, as a conventional control for the DAB type DC-DC converter as in the related art described above, when a phase difference between a primary-side bridge circuit and a secondary-side bridge circuit is controlled in a range of 0 to 90°, there is a possibility that the efficiency at the time of electric power conversion is decreased by the increase in an iron loss due to the use of the stator winding of the motor.

The present application aims at achieving prevention of an efficiency decrease at the time of electric power conversion in charging and electric power supply. Further, the present application contributes to energy efficiency.

An electric apparatus (for example, an electric apparatus 10 in the embodiment) according to a first aspect of the present invention includes: an electricity storage device (for example, an electricity storage device 11 in the embodiment); a rotary electric machine (for example, a rotary electric machine 16 (M) in the embodiment) including a first coil (for example, an α-phase first coil 23 (α1) in the embodiment) and a second coil (for example, an α-phase second coil 24 (α2) in the embodiment); and an electric power control unit (for example, an electric power control unit 10a in the embodiment) that is connected to the electricity storage device and the rotary electric machine and controls electric power transfer of each of the electricity storage device and the rotary electric machine, wherein the electric power control unit includes: a first full-bridge circuit (for example, a first full-bridge circuit 12a in the embodiment) connected to both ends of the first coil; and a second full-bridge circuit (for example, a second full-bridge circuit 12b in the embodiment) connected to both ends of the second coil, and when electric power is transmitted via the first coil and the second coil between the first full-bridge circuit and the second full-bridge circuit, a phase difference between the first full-bridge circuit and the second full-bridge circuit is controlled in a range that includes 90° to 180°.

A second aspect is the electric apparatus according to the first aspect described above, wherein the first coil and the second coil may be open-ended, and the rotary electric machine may include a stator core (for example, a stator core 42 in the embodiment) on which a slot (for example, a slot 43 in the embodiment) shared by the first coil and the second coil that are magnetically coupled is formed.

A third aspect is the electric apparatus according to the second aspect described above, wherein the rotary electric machine may include one or more coils (for example, a β-phase first coil 33 (β1) and a β-phase second coil 34 (β2) in the embodiment) connected to an external electric power source, the electric power control unit may include: a first connection-disconnection device (for example, a first connection-disconnection device 25 in the embodiment) that is connected between positive electrodes of the first full-bridge circuit and the second full-bridge circuit; a second connection-disconnection device (for example, a second connection-disconnection device 26 in the embodiment) that is connected between negative electrodes of the first full-bridge circuit and the second full-bridge circuit; one or more third full-bridge circuits (for example, a third full-bridge circuit 13a and a fourth full-bridge circuit 13b in the embodiment) that are connected to both ends of the one or more coils; and at least one third connection-disconnection device (for example, a third connection-disconnection device 35 and a fourth connection-disconnection device 36 in the embodiment) that is connected between one end of the one or more coils and the one or more third full-bridge circuits, and the electric apparatus may include an electric power source connection member (for example, an AC electric power source connection portion 15 in the embodiment) that is connected to both ends of the third connection-disconnection device and thereby connects the electric power control unit and the one or more coils to the external electric power source.

An electric apparatus control method according to a fourth aspect of the present invention is a control method of an electric apparatus that includes: an electricity storage device (for example, an electricity storage device 11 in the embodiment); a rotary electric machine (for example, a rotary electric machine 16 (M) in the embodiment) including a first coil (for example, an α-phase first coil 23 (α1) in the embodiment) and a second coil (for example, an α-phase second coil 24 (α2) in the embodiment); and an electric power control unit (for example, an electric power control unit 10a in the embodiment) that includes: a first full-bridge circuit (for example, a first full-bridge circuit 12a in the embodiment) connected to both ends of the first coil; and a second full-bridge circuit (for example, a second full-bridge circuit 12b in the embodiment) connected to both ends of the second coil, is connected to the electricity storage device and the rotary electric machine, and controls electric power transfer of each of the electricity storage device and the rotary electric machine, the electric apparatus control method including: controlling a phase difference between the first full-bridge circuit and the second full-bridge circuit in a range that includes 90° to 180° when electric power is transmitted via the first coil and the second coil between the first full-bridge circuit and the second full-bridge circuit.

According to the first aspect described above, in the case where insulation-type electric power conversion is performed by the first coil and the second coil of the rotary electric machine, for example, even when a ratio of an iron loss relative to the total loss is increased due to a material that forms the rotary electric machine, the iron loss can be reduced by a control that is different from an ordinary control. That is, by controlling the phase difference between the first full-bridge circuit and the second full-bridge circuit in a relatively large range that includes 90° to 180°, it is possible to decrease the sum of the current that flows through the first coil and the second coil, and by the increase of the magnetic flux that is canceled between the primary side and the secondary side, it is possible to reduce the iron loss and effectively prevent the decrease of the efficiency.

In the case of the second aspect described above, even when the material that forms the stator core of the rotary electric machine has, for example, a magnetic property which prioritizes a high magnetic flux density and in which the loss in a high frequency range is increased, it is possible to effectively prevent the decrease of the efficiency by the reduction of the iron loss. It is possible to improve an electric power conversion efficiency by the first coil and the second coil that are magnetically coupled.

In the case of the third aspect described above, at the time of driving of the rotary electric machine by the electricity storage device, the electric power control unit can function as an inverter of a quadruple full-bridge circuit. At the time of DC charging of the electricity storage device by the external electric power source, the combination of each coil of the rotary electric machine and each full-bridge circuit of the electric power control unit can function as a non-insulation type DC-DC converter. At the time of AC charging of the electricity storage device by the external electric power source, the combination of the first coil and the second coil of the rotary electric machine, the first full-bridge circuit, and the second full-bridge circuit can function as an insulation-type bidirectional DC-DC converter. For example, in the case of the voltage increase operation at the time of AC charging, it is possible to perform rapid charging with respect to a voltage of the electricity storage device that is larger than the charging voltage by the external electric power source.

According to the fourth aspect described above, in the case where insulation-type electric power conversion is performed by the first coil and the second coil of the rotary electric machine, for example, even when the ratio of an iron loss relative to the total loss is increased due to a material that forms the rotary electric machine, the iron loss can be reduced by a control that is different from an ordinary control. That is, by controlling the phase difference between the first full-bridge circuit and the second full-bridge circuit in a relatively large range that includes 90° to 180°, it is possible to decrease the sum of the current that flows through the first coil and the second coil, and by the increase of the magnetic flux that is canceled between the primary side and the secondary side, it is possible to reduce the iron loss and effectively prevent the decrease of the efficiency.

### BRIEF DESCRIPTION OF THE DRAWINGS

FIG. 1 is a view showing the configuration of an electric apparatus of an embodiment of the present invention.

FIG. 2 is a configuration view of each full-bridge circuit and a rotary electric machine in the electric apparatus of the embodiment of the present invention.

FIG. 3 is a view showing an example of a time change of a current of each α-phase coil in the embodiment of the present invention and a comparative example.

FIG. 4 is a view showing an example of changes in an output electric power and a loss (an iron loss and a copper loss) depending on the phase between a first full-bridge circuit and a second full-bridge circuit in the embodiment of the present invention and the comparative example.

FIG. 5 is a configuration view of a rotary electric machine of an electric apparatus in a modification example of the embodiment of the present invention.

### DESCRIPTION OF EMBODIMENTS

Hereinafter, an electric apparatus according to an embodiment of the present invention will be described referring to the accompanying drawings.

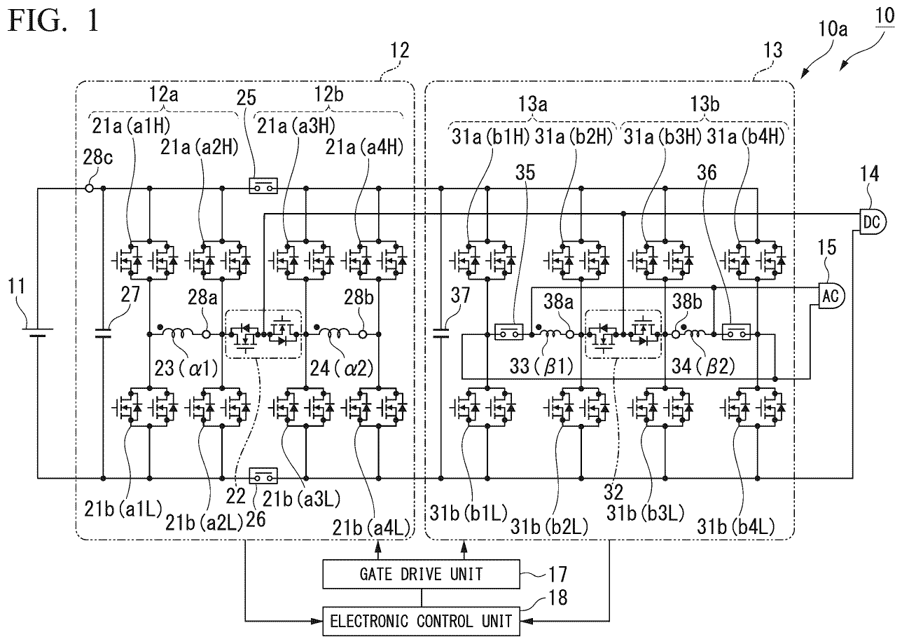

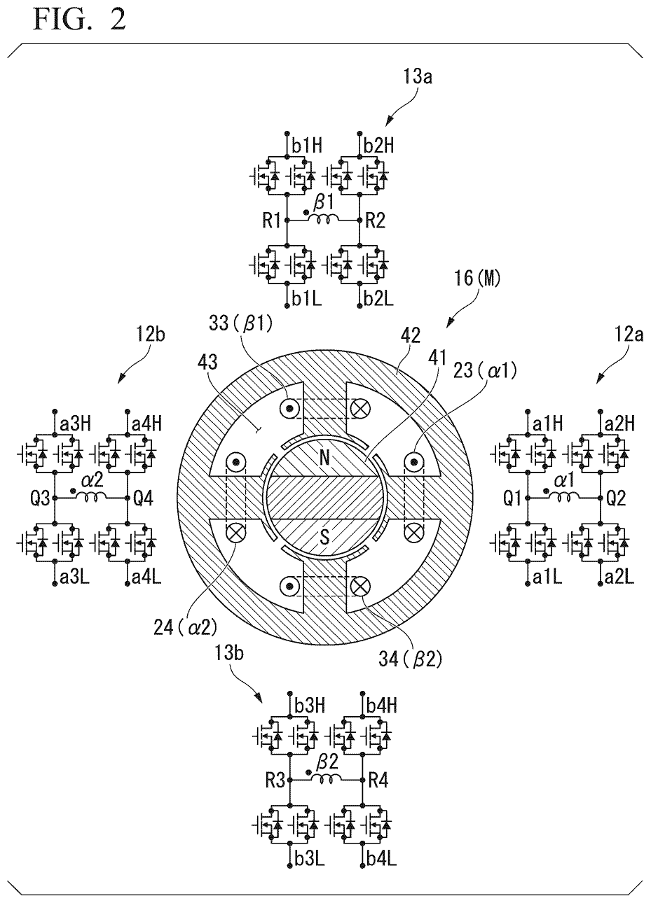

FIG. 1 is a view showing the configuration of an electric apparatus 10 of an embodiment. FIG. 2 is a configuration view of full-bridge circuits 12a, 12b, 13a, 13b and a rotary electric machine 16 in the electric apparatus 10 of the embodiment.

The electric apparatus 10 of the embodiment is mounted, for example, on an electric vehicle, an electric movable body, an electric machine, an electric power source apparatus, and the like. The electric vehicle is, for example, an electric automobile that includes a rotary electric machine as a power source, a saddle riding vehicle, a kick skater, a hybrid vehicle made by combining a rotary electric machine and an internal combustion engine, a fuel cell vehicle made by combining an electricity storage device and a fuel cell, and the like. The electric movable body is, for example, a robot, a flying vehicle, a movable body on water, an underwater movable body, and the like. The electric machine is, for example, a construction machinery that includes a rotary electric machine as a power source and the like. The electric power source apparatus is, for example, a stationary or mobile electric power source apparatus that performs discharging and charging of an electricity storage device and the like.

### (Electric Apparatus)

As shown in FIG. 1 and FIG. 2, the electric apparatus 10 of the embodiment includes, for example, an electricity storage device 11, a first electric power conversion portion 12, a second electric power conversion portion 13, a DC electric power source connection portion 14, an AC electric power source connection portion 15 (electric power source connection member), a rotary electric machine 16 (M), a gate drive unit 17, and an electronic control unit 18. For example, the first electric power conversion portion 12, the second electric power conversion portion 13, the DC electric power source connection portion 14, the AC electric power source connection portion 15, the gate drive unit 17, and the electronic control unit 18 constitute an electric power control unit 10a.

The electricity storage device 11 is connected to the first electric power conversion portion 12 and the second electric power conversion portion 13 described later.

The electricity storage device 11 includes, for example, a plurality of battery cells that are connected in series or in parallel. Each battery cell is, for example, a lead storage battery, a lithium-ion battery, a secondary battery such as a nickel hydride battery and an all-solid-state battery, a capacitor such as an electric double layer capacitor, or a compound battery made by combining a secondary battery and a capacitor. Each battery cell repeatedly performs charging and discharging. The electricity storage device 11 transfers electric power to and from the rotary electric machine 16 via the electric power control unit 10a. The electricity storage device 11 is charged by an external electric power source (an external DC electric power source and an external AC electric power source).

The first electric power conversion portion 12 includes a first full-bridge circuit 12a and a second full-bridge circuit 12b.

Each of the first full-bridge circuit 12a and the second full-bridge circuit 12b includes, for example, a so-called H-bridge circuit formed of a plurality of switching elements connected in two phases by bridge connection. Each switching element is, for example, a transistor of a SiC (Silicon Carbide) or the like, such as a MOSFET (Metal Oxide Semi-conductor Field Effect Transistor) or an IGBT (Insulated Gate Bipolar Transistor). Each switching element is, for example, an N-channel type MOSFET.

The plurality of switching elements are, for example, a pair of transistors forming each of high-side arm and low-side arm element portions 21a, 21b that form a pair in each phase. Each pair of transistors of each element portion 21a, 21b are connected, for example, in parallel.

Each full-bridge circuit 12a, 12b may include, for example, a rectifier element such as a reflux diode which is connected in parallel between a collector and an emitter of each transistor in a forward direction toward the collector from the emitter.

The first electric power conversion portion 12 includes, for example, a first switch 22 connected between neutral points Q2, Q3 of the first full-bridge circuit 12a and the second full-bridge circuit 12b. The neutral point Q2 of the first full-bridge circuit 12a is, for example, a connection point between a high-side arm element portion 21a (a2H) and a low-side arm element portion 21b (a2L) that are connected in series in a second phase among first and second phases of two phases of the first full-bridge circuit 12a. For example, the neutral point Q2 is a connection point between a source of the high-side arm element portion 21a (a2H) and a drain of the low-side arm element portion 21b (a2L). The neutral point Q3 of the second full-bridge circuit 12b is, for example, a connection point between a high-side arm element portion 21a (a3H) and a low-side arm element portion 21b (a3L) that are connected in series in a first phase among first and second phases of two phases of the second full-bridge circuit 12b. For example, the neutral point Q3 is a connection point between a source of the high-side arm element portion 21a (a3H) and a drain of the low-side arm element portion 21b (a3L).

The first switch 22 is, for example, a bidirectional switch formed of two switching elements. Each switching element is a transistor such as a MOSFET or an IGBT and is, for example, an N-channel type MOSFET. The first switch 22 includes, for example, two transistors connected reversely in series. For example, the sources of the two transistors are connected to each other, and thereby, the two transistors are connected in series in a direction opposite to each other. The first switch 22 switches conduction and cutoff of a current between the neutral points Q2, Q3 by ON (conduction)/OFF (cutoff) of the two transistors.

Each transistor may include a rectifier element such as a reflux diode which is connected in parallel between a collector and an emitter in a forward direction toward the collector from the emitter.

The first electric power conversion portion 12 is connected to an α-phase first coil 23 (α1) and an α-phase second coil 24 (α2) of the rotary electric machine 16 described later. The α-phase first coil 23 is connected between neutral points Q1, Q2 of the first full-bridge circuit 12a. The α-phase second coil 24 (α2) is connected between neutral points Q3, Q4 of the second full-bridge circuit 12b. The neutral point Q1 of the first full-bridge circuit 12a is, for example, a connection point between a high-side arm element portion 21a (a1H) and a low-side arm element portion 21b (a1L) that are connected in series in the first phase of the first full-bridge circuit 12a. For example, the neutral point Q1 is a connection point between a source of the high-side arm element portion 21a (a1H) and a drain of the low-side arm element portion 21b (a1L). The neutral point Q4 of the second full-bridge circuit 12b is, for example, a connection point between a high-side arm element portion 21a (a4H) and a low-side arm element portion 21b (a4L) that are connected in series in the second phase of the second full-bridge circuit 12b. For example, the neutral point Q4 is a connection point between a source of the high-side arm element portion 21a (a4H) and a drain of the low-side arm element portion 21b (a4L).

The first electric power conversion portion 12 includes a first connection-disconnection device 25 connected between positive electrodes of the first full-bridge circuit 12a and the second full-bridge circuit 12b and a second connection-disconnection device 26 connected between negative electrodes of the first full-bridge circuit 12a and the second full-bridge circuit 12b.

Each of the first connection-disconnection device 25 and the second connection-disconnection device 26 is, for example, a contactor and switches between ON (conduction) and OFF (cutoff) of the connection between the first full-bridge circuit 12a and the second full-bridge circuit 12b.

The first electric power conversion portion 12 includes, for example, a capacitor (condenser) 27 connected between the positive electrode and the negative electrode. For example, the capacitor 27 smooths voltage variation generated in accordance with a switching operation between ON (conduction) and OFF (cutoff) of each switching element of the first electric power conversion portion 12.

The first electric power conversion portion 12 includes, for example, a first current sensor 28a arranged between the α-phase first coil 23 (α1) and the neutral point Q2, a second current sensor 28b arranged between the α-phase second coil 24 (α2) and the neutral point Q4, and a third current sensor 28c arranged between the electricity storage device 11 and the first electric power conversion portion 12.

For example, the first current sensor 28a detects a current that flows through the α-phase first coil 23 (α1). The second current sensor 28b detects a current that flows through the α-phase second coil 24 (α2).

The third current sensor 28c detects a current that flows between the first electric power conversion portion 12 and the electricity storage device 11.

The second electric power conversion portion 13 includes a third full-bridge circuit 13a and a fourth full-bridge circuit 13b.

Each of the third full-bridge circuit 13a and the fourth full-bridge circuit 13b includes, for example, a so-called H-bridge circuit formed of a plurality of switching elements connected in two phases by bridge connection. Each switching element is, for example, a transistor of a SiC or the like, such as a MOSFET or an IGBT. Each switching element is, for example, an N-channel type MOSFET.

The plurality of switching elements are, for example, a pair of transistors forming each of high-side arm and low-side arm element portions 31a, 31b that form a pair in each phase. Each pair of transistors of each element portion 31a, 31b are connected, for example, in parallel.

Each full-bridge circuit 13a, 13b may include, for example, a rectifier element such as a reflux diode which is connected in parallel between a collector and an emitter of each transistor in a forward direction toward the collector from the emitter.

The second electric power conversion portion 13 includes, for example, a second switch 32 connected between neutral points R2, R3 of the third full-bridge circuit 13a and the fourth full-bridge circuit 13b. The neutral point R2 of the third full-bridge circuit 13a is, for example, a connection point between a high-side arm element portion 31a (b2H) and a low-side arm element portion 31b (b2L) that are connected in series in a second phase among first and second phases of two phases of the third full-bridge circuit 13a. For example, the neutral point R2 is a connection point between a source of the high-side arm element portion 31a (b2H) and a drain of the low-side arm element portion 31b (b2L). The neutral point R3 of the fourth full-bridge circuit 13b is, for example, a connection point between a high-side arm element portion 31a (b3H) and a low-side arm element portion 31b (b3L) that are connected in series in a first phase among first and second phases of two phases of the fourth full-bridge circuit 13b. For example, the neutral point R3 is a connection point between a source of the high-side arm element portion 31a (b3H) and a drain of the low-side arm element portion 31b (b3L).

The second switch 32 is, for example, a bidirectional switch formed of two switching elements. Each switching element is a transistor such as a MOSFET or an IGBT and is, for example, an N-channel type MOSFET. The second switch 32 includes, for example, two transistors connected reversely in series. For example, the sources of the two transistors are connected to each other, and thereby, the two transistors are connected in series in a direction opposite to each other. The second switch 32 switches conduction and cutoff of a current between the neutral points R2, R3 by ON (conduction)/OFF (cutoff) of the two transistors.

Each transistor may include a rectifier element such as a reflux diode which is connected in parallel between a collector and an emitter in a forward direction toward the collector from the emitter.

The second electric power conversion portion 13 is connected to a β-phase first coil 33 (β1) and a β-phase second coil 34 (β2) of the rotary electric machine 16 described later. The β-phase first coil 33 is connected between neutral points R1, R2 of the third full-bridge circuit 13a. The β-phase second coil 34 (β2) is connected between neutral points R3, R4 of the fourth full-bridge circuit 13b. The neutral point R1 of the third full-bridge circuit 13a is, for example, a connection point between a high-side arm element portion 31a (b1H) and a low-side arm element portion 31b (b1L) that are connected in series in the first phase of the third full-bridge circuit 13a. For example, the neutral point R1 is a connection point between a source of the high-side arm element portion 31a (b1H) and a drain of the low-side arm element portion 31b (b1L). The neutral point R4 of the fourth full-bridge circuit 13b is, for example, a connection point between a high-side arm element portion 31a (b4H) and a low-side arm element portion 31b (b4L) that are connected in series in the second phase of the fourth full-bridge circuit 13b. For example, the neutral point R4 is a connection point between a source of the high-side arm element portion 31a (b4H) and a drain of the low-side arm element portion 31b (b4L).

The second electric power conversion portion 13 includes a third connection-disconnection device 35 connected between one end of the β-phase first coil 33 (β1) and the third full-bridge circuit 13a and a fourth connection-disconnection device 36 connected between one end of the β-phase second coil 34 (β2) and the fourth full-bridge circuit 13b.

Each of the third connection-disconnection device 35 and the fourth connection-disconnection device 36 is, for example, a contactor. The third connection-disconnection device 35 is connected, for example, between the one end of the β-phase first coil 33 (β1) and the neutral point R1 of the first phase of the third full-bridge circuit 13a and switches between ON (conduction) and OFF (cutoff) of the connection between the β-phase first coil 33 (β1) and the neutral point R1. The fourth connection-disconnection device 36 is connected, for example, between the one end of the β-phase second coil 34 (β2) and the neutral point R4 of the second phase of the fourth full-bridge circuit 13b and switches between ON (conduction) and OFF (cutoff) of the connection between the β-phase second coil 34 (β2) and the neutral point R4.

The second electric power conversion portion 13 includes, for example, a capacitor (condenser) 37 connected between the positive electrode and the negative electrode. For example, the capacitor 37 smooths voltage variation generated in accordance with a switching operation between ON (conduction) and OFF (cutoff) of each switching element of the second electric power conversion portion 13.

The second electric power conversion portion 13 includes, for example, a fourth current sensor 38a arranged between the β-phase first coil 33 (β1) and the neutral point R2 and a fifth current sensor 38b arranged between the β-phase second coil 34 (β2) and the neutral point R4.

For example, the fourth current sensor 38a detects a current that flows through the β-phase first coil 33 (β1). The fifth current sensor 38b detects a current that flows through the β-phase second coil 34 (β2).

The DC electric power source connection portion 14 and the AC electric power source connection portion 15 include, for example, a connection device (connector) or the like for DC electric power and for AC electric power of a predetermined standard. The DC electric power source connection portion 14 and the AC electric power source connection portion 15 are connected, for example, to a DC electric power source (external DC electric power source) and an AC electric power source (external AC electric power source) at the outside on the basis of a commercial electric power source or the like connected to an electric power system.

The DC electric power source connection portion 14 is connected, for example, to the negative electrode of the second electric power conversion portion 13 and to a neutral point (that is, a point between the two transistors connected reversely in series) of each of the first switch 22 and the second switch 32.

The AC electric power source connection portion 15 is connected, for example, to each of the first neutral point R1 and the fourth neutral point R4 of the second electric power conversion portion 13 and to each of the connection point between the β-phase first coil 33 (β1) and the third connection-disconnection device 35 and the connection point between the β-phase second coil 34 (β2) and the fourth connection-disconnection device 36.

The rotary electric machine 16 (M) is, for example, a two-phase AC brushless DC motor. The rotary electric machine 16 includes, for example, the α-phase first coil 23 (α1), the α-phase second coil 24 (α2), the β-phase first coil 33 (β1), the β-phase second coil 34 (β2), a rotor 41, and a stator core 42.

The rotor 41 includes a field permanent magnet. The stator core 42 is formed, for example, of an electromagnetic steel sheet such as a silicon steel. Each coil α1, α2, β1, β2 that generates a rotating magnetic field which rotates the rotor 41 is attached to the stator core 42.

The α-phase first coil 23 (α1), the α-phase second coil 24 (α2), the β-phase first coil 33 (β1), and the β-phase second coil 34 (β2) are so-called open-ended coils, and ends of the coils α1, α2, β1, β2 are not connected to each other (that is, the coils α1, α2, β1, β2 are separated from each other) and are drawn out to the outside of the rotary electric machine 16.

The α-phase first coil 23 (α1) and the α-phase second coil 24 (α2) set, for example, a spatial phase difference from each other to be zero and are wound with respect to the different teeth of the stator core 42 in the same direction when seen from an axis direction along a center axis of the rotary electric machine 16 (M). The α-phase first coil 23 (α1) and the α-phase second coil 24 (α2) are arranged, for example, so as to share part of a slot 43 formed in the stator core 42 and are magnetically coupled to each other in the same polarity.

The β-phase first coil 33 (β1) and the β-phase second coil 34 (β2) cause, for example, a spatial phase difference from each other to be zero and are wound with respect to the different teeth of the stator core 42 in the same direction when seen from the axis direction along the center axis of the rotary electric machine 16 (M). The β-phase first coil 33 (β1) and the β-phase second coil 34 (β2) are arranged, for example, so as to share part of the slot 43 formed in the stator core 42 and are magnetically coupled to each other in the same polarity.

The α-phase first coil 23 (α1), the α-phase second coil 24 (α2), the β-phase first coil 33 (β1), and the β-phase second coil 34 (β2) are arranged such that the α-phase first coil 23 (α1) and the α-phase second coil 24 (α2) do not magnetically interfere with the β-phase first coil 33 (β1) and the β-phase second coil 34 (β2) by setting the spatial phase difference from each other to be 90°.

For example, each coil α1, α2, β1, β2 is attached to the stator core 42 by concentrated winding, distributed winding, or the like, and the coils α1, α2, β1, β2 have the same number of winding as one another.

The rotary electric machine 16 (M) generates rotation power by performing a power running operation using electric power supplied from the first electric power conversion portion 12 and the second electric power conversion portion 13. For example, when the rotary electric machine 16 (M) is connected to a wheel of the vehicle, the rotary electric machine 16 (M) generates a travel drive force by the electric power supplied from the first electric power conversion portion 12 and the second electric power conversion portion 13. The rotary electric machine 16 (M) may generate electric power by performing a regeneration operation using rotation power input from the wheel side of the vehicle. For example, when the rotary electric machine 16 (M) is connected to the internal combustion engine of the vehicle, the rotary electric machine 16 (M) may generate electric power using the power of the internal combustion engine.

The gate drive unit 17 switches between ON (conduction) and OFF (cutoff) of each connection-disconnection device 25, 26, 35, 36, 39 and each switching element of the first electric power conversion portion 12 and the second electric power conversion portion 13 on the basis of a control signal received from the electronic control unit 18. For example, the gate drive unit 17 switches between ON (conduction) and OFF (cutoff) of each switching element of each full-bridge circuit 12a, 12b, 13a, 13b by outputting a gate signal generated by amplification, level shift, and the like of the control signal.

The electronic control unit 18 integrally controls an operation of each of the electric power control unit 10a and the rotary electric machine 16 (M). For example, the electronic control unit 18 is a software function unit that functions by a predetermined program being executed by a processor such as a CPU (Central Processing Unit). The software function unit is an ECU (Electronic Control Unit) that includes the processor such as a CPU, a ROM (Read Only Memory) that stores the program, a RAM (Random Access Memory) that temporarily stores data, and an electronic circuit such as a timer. At least part of the electronic control unit 18 may be an integrated circuit such as a LSI (Large Scale Integration).

The electronic control unit 18 generates a control signal indicating a timing when each connection-disconnection device 25, 26, 35, 36, 39 and each switching element of the first electric power conversion portion 12 and the second electric power conversion portion 13 are driven to ON (conduction) and OFF (cutoff). The electronic control unit 18 inputs the generated control signal to the gate drive unit 17.

### (Control Operation of Electric Apparatus)

The electronic control unit 18 sets the first connection-disconnection device 25 and the second connection-disconnection device 26 to an ON (conduction) state in the case of the power running operation or the regeneration operation of the rotary electric machine 16 (M). The electronic control unit 18 switches between a state of the series connection of the α-phase coils α1, α2 and the series connection of the β-phase coils β1, β2, and a state of the parallel connection of the α-phase coils α1, α2 and the parallel connection of the β-phase coils β1, β2 by the switching between ON (conduction) and OFF (cutoff) of the first switch 22 and the second switch 32.

The electronic control unit 18 performs, for example, a feedback control or the like of a current in which a current detection value of the rotary electric machine 16 (M) and a current target value in response to a torque command value of the rotary electric machine 16 (M) are used and generates a control signal that commands the driving of each switching element of the first electric power conversion portion 12 and the second electric power conversion portion 13.

At the time of DC charging, that is, when the electricity storage device 11 is charged by the external DC electric power source connected to the DC electric power source connection portion 14, the electronic control unit 18 sets the first connection-disconnection device 25 and the second connection-disconnection device 26 to be in an ON (conduction) state. The electronic control unit 18 causes each of the combination of the α-phase coils α1, α2 and the first electric power conversion portion 12 and the combination of the β-phase coils β1, β2 and the second electric power conversion portion 13 to function as a non-insulation type DC-DC converter that performs a voltage increase operation by a so-called chopper control, for example, with respect to the external DC electric power source having a lower voltage than that of the electricity storage device 11.

At the time of AC charging, that is, when the electricity storage device 11 is charged by the external AC electric power source connected to the AC electric power source connection portion 15, the electronic control unit 18 sets the first connection-disconnection device 25 and the second connection-disconnection device 26 to be in an OFF (cutoff) state for insulation.

The electronic control unit 18 sets, for example, the α-phase first coil 23 (α1) and the α-phase second coil 24 (α2) that are magnetically coupled to each other in the same polarity to be a coil of a DC conversion phase (a phase) used for conversion between DC electric power. The electronic control unit 18 causes, for example, the combination of the α-phase coils α1, α2 and the first electric power conversion portion 12 to function as a DAB (Dual Active Bridge) type DC-DC converter which is an insulation-type bidirectional (a voltage increase and a voltage decrease) converter.

The electronic control unit 18 sets, for example, the β-phase first coil 33 (β1) and the β-phase second coil 34 (β2) that are magnetically coupled to each other in the same polarity to be a coil of an AC electric power source input phase (β phase) connected to the external AC electric power source. The electronic control unit 18 causes, for example, the combination of the β-phase coils β1, β2 and the second electric power conversion portion 13 to function as a so-called full-bridgeless type (or bridgeless and totem pole type) power factor correction (PFC) circuit which converts AC electric power into DC electric power. The so-called bridgeless PFC is a PFC that does not include a bridge rectifier by a plurality of diodes which are connected by bridge connection. The so-called totem pole PFC is a PFC that includes a pair of switching elements of the same conductivity type which are connected (totem pole connection) in series in the same direction. The electronic control unit 18 performs the power factor correction of an input voltage Vac and an input current Iac while performing rectification of AC electric power received from the external AC electric power source into DC electric power and increasing the voltage, for example, by controlling the switching of each switching element in each full-bridge circuit 13a, 13b of the second electric power conversion portion 13.

For example, when electric power is transmitted between the first full-bridge circuit 12a and the second full-bridge circuit 12b via the α-phase first coil 23 (α1) and the α-phase second coil 24 (α2), the electronic control unit 18 controls the phase difference between the first full-bridge circuit 12a and the second full-bridge circuit 12b in a range that includes 90° to 180° in addition to a range from 0° to 90°.

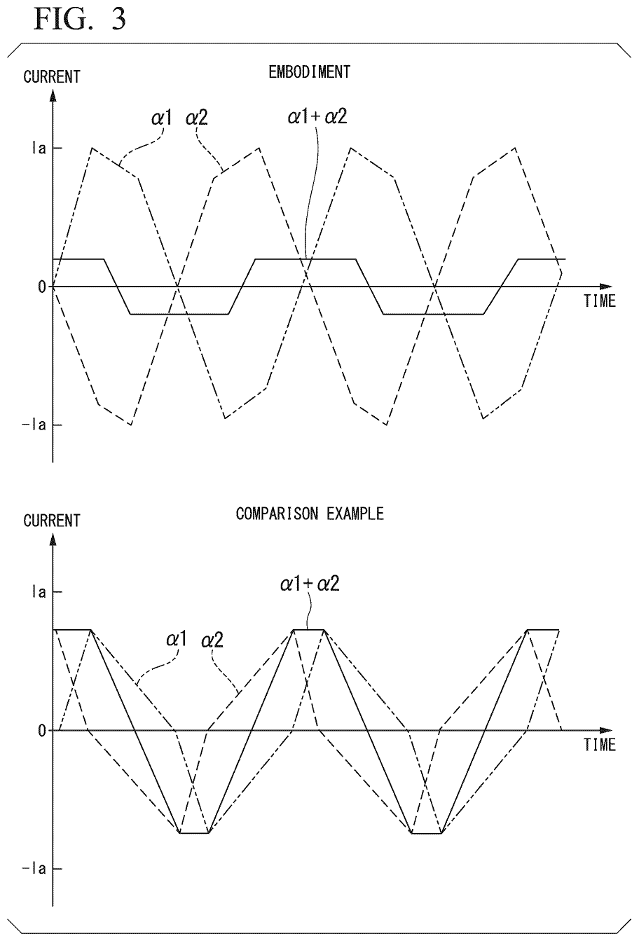

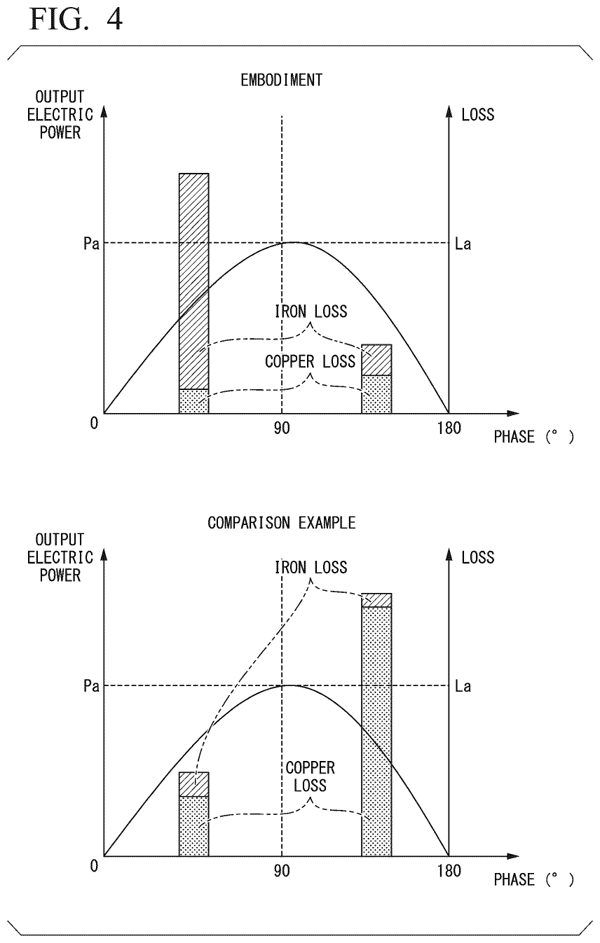

FIG. 3 is a view showing an example of a time change of a current of each α-phase coil α1, α2 in the embodiment and a comparative example. FIG. 4 is a view showing an example of changes in an output electric power and a loss (an iron loss and a copper loss) depending on the phase between the first full-bridge circuit 12a and the second full-bridge circuit 12b in the embodiment and the comparative example.

In the embodiment and the comparative example shown in FIG. 3, for example, with respect to the combination of each full-bridge circuit 12a, 12b of the first electric power conversion portion 12 and each α-phase coil α1, α2 of the rotary electric machine 16 (M), conditions of a primary-side voltage, a secondary-side voltage, a switching frequency, an output, and the like are the same. The embodiment corresponds to the case where the phase difference between the full-bridge circuits 12a, 12b is controlled in the range (for example, 136° or the like) that includes 90° to 180°. The comparative example corresponds to the case where the phase difference between the full-bridge circuits 12a, 12b is controlled in the range (for example, 44° or the like) from 0° to 90°. In the embodiment, as compared with the comparative example, it is recognized that, although the current of each α-phase coil α1, α2 is increased, the phase difference is large, and thereby, the sum of the currents of the α-phase coils α1, α2 is decreased. In the embodiment, as compared with the comparative example, the sum of the currents of the α-phase coils α1, α2 is decreased, and the iron loss is reduced by the increase of the magnetic flux canceled between the primary side and the secondary side.

In the embodiment and the comparative example shown in FIG. 4, for example, the output electric power is identical. The embodiment corresponds to a DAB type DC-DC converter by the combination of the full-bridge circuits 12a, 12b of the first electric power conversion portion 12 and the α-phase coils α1, α2 of the rotary electric machine 16 (M). The comparative example corresponds, for example, to a DAB type DC-DC converter having a core made of a material which is different from that of the embodiment. The stator core 42 of the rotary electric machine 16 (M) of the embodiment is formed of, for example, an electromagnetic steel sheet such as a silicon steel. The core of the comparative example is a powder magnetic core formed of, for example, soft magnetic iron powder or the like. In the comparative example, it is recognized that the copper loss is larger than the iron loss, and the copper loss is increased when the phase difference is in the range from 90° to 180°. In the embodiment, it is recognized that the iron loss is larger than the copper loss when the phase difference is in the range from 0° to 90°, and the total loss is reduced in accordance with the decrease of the iron loss when the phase difference is in the range from 90° to 180°.

As described above, according to the electric apparatus 10 and the control method of the electric apparatus 10 of the embodiment, in the case where the insulation-type electric power conversion is performed by the α-phase coils 23 (α1), 24 (α2) of the rotary electric machine 16 (M), for example, even when the ratio of the iron loss relative to the total loss is increased due to the material that forms the rotary electric machine 16 (M), the iron loss can be reduced by the control that is different from the ordinary control. By controlling the phase difference between the first full-bridge circuit 12a and the second full-bridge circuit 12b in the relatively large range that includes 90° to 180°, it is possible to decrease the sum of the current that flows through the α-phase coils 23 (α1), 24 (α2), and by the increase of the magnetic flux that is canceled between the primary side and the secondary side, it is possible to reduce the iron loss and effectively prevent a decrease of the efficiency.

Even when the material that forms the stator core 42 of the rotary electric machine 16 (M) has, for example, a magnetic property as in an electromagnetic steel sheet or the like which prioritizes a high magnetic flux density and in which the loss in a high frequency range is increased, it is possible to effectively prevent a decrease of the efficiency by the reduction of the iron loss. It is possible to improve an electric power conversion efficiency by the α-phase coils 23 (α1), 24 (α2) that are magnetically coupled. At the time of driving of the rotary electric machine 16 (M) by the electricity storage device 11, the electric power control unit 10a can function as an inverter of a quadruple full-bridge circuit. At the time of DC charging of the electricity storage device 11 by the external electric power source, the combination of each coil of the rotary electric machine 16 (M) and each full-bridge circuit can function as a non-insulation type DC-DC converter. At the time of AC charging of the electricity storage device 11 by the external electric power source, the combination of the α-phase coils 23 (α1), 24 (α2) of the rotary electric machine 16 (M), the first full-bridge circuit 12a, and the second full-bridge circuit 12b can function as an insulation-type bidirectional DC-DC converter. For example, in the case of the voltage increase operation at the time of AC charging, it is possible to perform rapid charging with respect to a voltage of the electricity storage device 11 that is larger than the charging voltage by the external electric power source.

### Modification Example

Hereinafter, modification examples of the embodiment will be described. The same parts as those of the above-described embodiment are denoted by the same reference numerals, and descriptions thereof are omitted or simplified.

The above embodiment is described using an example in which each of the α-phase first coil 23 (α1), the α-phase second coil 24 (α2), the β-phase first coil 33 (β1), and the β-phase second coil 34 (β2) is wound around the different teeth of the stator core 42; however, the embodiment is not limited thereto.

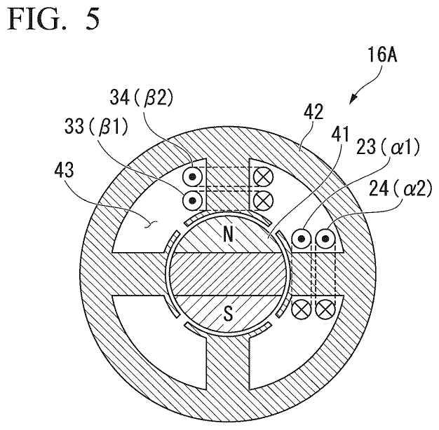

FIG. 5 is a configuration view of a rotary electric machine 16A of the electric apparatus 10 in a modification example of the embodiment.

As shown in FIG. 5, the α-phase first coil 23 (α1) and the α-phase second coil 24 (α2) may be wound around the same teeth of the stator core 42, and the β-phase first coil 33 (β1) and the β-phase second coil 34 (β2) may be wound around the same teeth of the stator core 42.

The above embodiment is described using an example in which the β-phase first coil 33 (β1) and the β-phase second coil 34 (β2) are magnetically coupled to each other in the same polarity; however, the embodiment is not limited thereto. The β-phase first coil 33 (β1) and the β-phase second coil 34 (β2) may be magnetically coupled to each other in an opposite polarity. In this case, for example, a connection-disconnection device connected between one end of the β-phase first coil 33 (β1) and the neutral point R2 of the second phase of the third full-bridge circuit 13a or a connection-disconnection device connected between one end of the β-phase second coil 34 (β2) and the neutral point R3 of the first phase of the fourth full-bridge circuit 13b may be provided.

The above embodiment is described using an example in which at the time of AC charging, the current flows from the external AC electric power source to the β-phase first coil 33 (β1) and the β-phase second coil 34 (β2); however, the embodiment is not limited thereto. For example, at least one of a connection-disconnection device that switches between ON (conduction) and OFF (cutoff) of the connection between the AC electric power source connection portion 15 and the β-phase first coil 33 (β1) and a connection-disconnection device that switches between ON (conduction) and OFF (cutoff) of the connection between the AC electric power source connection portion 15 and the β-phase second coil 34 (β2) may be provided. In this case, a current may be set to flow only through the β-phase first coil 33 (β1) or the β-phase second coil 34 (β2).

The above embodiment is described using an example in which, as a parallel pattern, the DC electric power source connection portion 14 is connected to the negative electrode of the second electric power conversion portion 13 and to the neutral point (that is, between the two transistors connected reversely in series) of each of the first switch 22 and the second switch 32; however, the embodiment is not limited thereto. For example, as a serial pattern, the DC electric power source connection portion 14 may be connected to the negative electrode of the second electric power conversion portion 13 and to the neutral point Q4 of the first electric power conversion portion 12 and the neutral point R4 of the second electric power conversion portion 13. For example, as another parallel pattern, the DC electric power source connection portion 14 may be connected to the negative electrode of the second electric power conversion portion 13 and to the neutral points Q2, Q4 of the first electric power conversion portion 12 and the neutral points R2, R4 of the second electric power conversion portion 13.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and the gist of the invention and are also included within the scope of the invention described in the appended claims and equivalents thereof.

What is claimed is:

1. An electric apparatus comprising:
an electricity storage device;
a rotary electric machine comprising a first coil and a second coil; and
an electric power control unit that is connected to the electricity storage device and the rotary electric machine and controls electric power transfer of each of the electricity storage device and the rotary electric machine,
wherein the electric power control unit comprises:
a first full-bridge circuit connected to both ends of the first coil; and
a second full-bridge circuit connected to both ends of the second coil, and
when electric power is transmitted via the first coil and the second coil between the first full-bridge circuit and the second full-bridge circuit, a phase difference between the first full-bridge circuit and the second full-bridge circuit is controlled in a range that includes 90° to 180°.

2. The electric apparatus according to claim 1,
wherein the first coil and the second coil are open-ended, and
the rotary electric machine comprises a stator core on which a slot shared by the first coil and the second coil that are magnetically coupled is formed.

3. The electric apparatus according to claim 2,
wherein the rotary electric machine comprises one or more coils connected to an external electric power source,
the electric power control unit comprises:
a first connection-disconnection device that is connected between positive electrodes of the first full-bridge circuit and the second full-bridge circuit;
a second connection-disconnection device that is connected between negative electrodes of the first full-bridge circuit and the second full-bridge circuit;
one or more third full-bridge circuits that are connected to both ends of the one or more coils; and
at least one third connection-disconnection device that is connected between one end of the one or more coils and the one or more third full-bridge circuits, and
the electric apparatus comprises an electric power source connection member that is connected to both ends of the third connection-disconnection device and thereby connects the electric power control unit and the one or more coils to the external electric power source.

4. An electric apparatus control method which is a control method of an electric apparatus that comprises:
an electricity storage device;
a rotary electric machine comprising a first coil and a second coil; and
an electric power control unit that comprises: a first full-bridge circuit connected to both ends of the first coil; and a second full-bridge circuit connected to both ends of the second coil, is connected to the electricity storage device and the rotary electric machine, and controls electric power transfer of each of the electricity storage device and the rotary electric machine, the electric apparatus control method including:
controlling a phase difference between the first full-bridge circuit and the second full-bridge circuit in a range that includes 90° to 180° when electric power is transmitted via the first coil and the second coil between the first full-bridge circuit and the second full-bridge circuit.
